(19) United States
(12) Patent Application Publication
(10) Pub. No.: US 2012/0299853 A1
(43) Pub. Date: Nov. 29, 2012

(54) HAPTIC INTERFACE

(76) Inventor: Sumit Dagar, New Delhi (IN)

(21) Appl. No.: 13/480,665

(22) Filed: May 25, 2012

Related U.S. Application Data
(60) Provisional application No. 61/490,209, filed on May 26, 2011.

(51) Int. Cl. G06F 3/041; G09G 5/00

(52) U.S. Cl. 345/173; 345/156

(57) ABSTRACT

Systems, apparatus, methods, and articles of manufacture that provide for improved haptic interfaces.

### CROSS-REFERENCE TO RELATED APPLICATIONS

The present application is a non-provisional of, and claims benefit and priority under 35 U.S.C. §119(e) to, U.S. Provisional Patent Application No. 61/490209 filed on May 26, 2011 and titled “IMPROVED HAPTIC INTERFACE”. The entirety of the above-reference application is hereby incorporated herein in the entirety.

### COPYRIGHT NOTICE

A portion of the disclosure of this patent document contains material which is subject to copyright protection. The copyright owner has no objection to the facsimile reproduction by any-one of the patent document or the patent disclosure, as it appears in the Patent and Trademark Office patent file or records, but otherwise reserves all copyright rights whatsoever.

### BACKGROUND

Keyboards and other output devices have been developed to assist the visually impaired by implementing haptic feedback mechanisms that allow a user to sense Braille characters. While such devices comprise welcome advancements in the field of accessible technologies, they have failed to provide an interface that is intuitive and promotes easy and efficient use, particularly of mobile devices operated by visually impaired users.

### BRIEF DESCRIPTION OF THE DRAWINGS

An understanding of embodiments described herein and many of the attendant advantages thereof may be readily obtained by reference to the following detailed description when considered with the accompanying drawings, wherein:

FIG. 1A and FIG. 1B are perspective diagrams of a mobile electronic device according to some embodiments;

FIG. 2A, FIG. 2B, FIG. 2C, FIG. 2D, FIG. 2E, and FIG. 2F are schematic cross-section diagrams of an example interface according to some embodiments;

FIG. 3 is a flow diagram of a method according to some embodiments;

FIG. 4A, FIG. 4B, FIG. 4C, and FIG. 4D are example mobile electronic devices according to some embodiments;

FIG. 5 is a block diagram of an apparatus according to some embodiments; and

FIG. 6 is a block diagram of an apparatus according to some embodiments.

### DETAILED DESCRIPTION

I. Introduction

Embodiments described herein are descriptive of systems, apparatus, methods, and articles of manufacture for improved haptic interfaces. In some embodiments, for example, the height of various regions and/or portions of a haptic interface may be varied to form different functional regions and/or portions of the haptic interface. In addition to changing height to output Braille characters, for example, whole areas of the haptic interface may be sunken, raised, and/or otherwise textured or varied to provide various indications to a user of the haptic interface. Braille characters in one distinguishable region may have one meaning or connotation, for example, while the same characters in another distinguishable region may have a second meaning and/or connotation.

II. Terms and Definitions

Some embodiments described herein are associated with a “Braille character”. As used herein, the term “Braille character” may be used generally to refer to any object configured and/or operable to convey information via a haptic interface. Raised bumps, indents, depressions, and/or other surface variations and/or textures may be utilized, for example, to convey information in accordance with the Braille alphabet and/or character sets. In some embodiments, surface objects may be utilized to convey shapes, pictures, images, sounds, textures, and/or other non-Braille characters and/or information.

As used herein, the term “haptic” may generally refer to any input, output, sensing, detection, and/or other information transmission or provision relating to an organic, electric, mechanical, and/or virtual somatosensory system. Haptic output may be detectable, for example, via various modalities such as touch (e.g., tactile feedback), temperature, proprioception, and/or nociception. While haptic interfacing may generally occur via a human digit such as a finger, any other portion of the human body having haptic receptors may also or alternatively be utilized in accordance with the embodiments described herein.

Some embodiments described herein are associated with a “user device” or a “network device”. As used herein, the terms “user device” and “network device” may be used interchangeably and may generally refer to any device that can communicate via a network. Examples of user or network devices include a Personal Computer (PC), a workstation, a server, a printer, a scanner, a facsimile machine, a copier, a Personal Digital Assistant (PDA), a storage device (e.g., a disk drive), a hub, a router, a switch, and a modem, a video game console, or a wireless phone. User and network devices may comprise one or more communication or network components.

As used herein, the term “network component” may refer to a user or network device, or a component, piece, portion, or combination of user or network devices. Examples of network components may include a Static Random Access Memory (SRAM) device or module, a network processor, and a network communication path, connection, port, or cable.

In addition, some embodiments are associated with a “network” or a “communication network”. As used herein, the terms “network” and “communication network” may be used interchangeably and may refer to any object, entity, component, device, and/or any combination thereof that permits, facilitates, and/or otherwise contributes to or is associated with the transmission of messages, packets, signals, and/or other forms of information between and/or within one or more network devices. Networks may be or include a plurality of interconnected network devices. In some embodiments, networks may be hard-wired, wireless, virtual, neural, and/or any other configuration of type that is or becomes known. Communication networks may include, for example, one or more networks configured to operate in accordance with the Fast Ethernet LAN transmission standard 802.3-2002® published by the Institute of Electrical and Electronics Engineers (IEEE). In some embodiments, a network may include one or more wired and/or wireless networks operated in accordance with any communication standard or protocol that is or becomes known or practicable.

As used herein, the terms “information” and “data” may be used interchangeably and may refer to any data, text, voice, video, image, message, bit, packet, pulse, tone, waveform, and/or other type or configuration of signal and/or information. Information may comprise information packets transmitted, for example, in accordance with the Internet Protocol Version 6 (IPv6) standard as defined by “Internet Protocol Version 6 (IPv6) Specification” RFC 1883, published by the Internet Engineering Task Force (IETF), Network Working Group, S. Deering et al. (December 1995). Information may, according to some embodiments, be compressed, encoded, encrypted, and/or otherwise packaged or manipulated in accordance with any method that is or becomes known or practicable.

In addition, some embodiments described herein are associated with an “indication”. As used herein, the term “indication” may be used to refer to any indicia and/or other information indicative of or associated with a subject, item, entity, and/or other object and/or idea. As used herein, the phrases “information indicative of” and “indicia” may be used to refer to any information that represents, describes, and/or is otherwise associated with a related entity, subject, or object. Indicia of information may include, for example, a code, a reference, a link, a signal, an identifier, and/or any combination thereof and/or any other informative representation associated with the information. In some embodiments, indicia of information (or indicative of the information) may be or include the information itself and/or any portion or component of the information. In some embodiments, an indication may include a request, a solicitation, a broadcast, and/or any other form of information gathering and/or dissemination.

III. Improved Haptic Interface

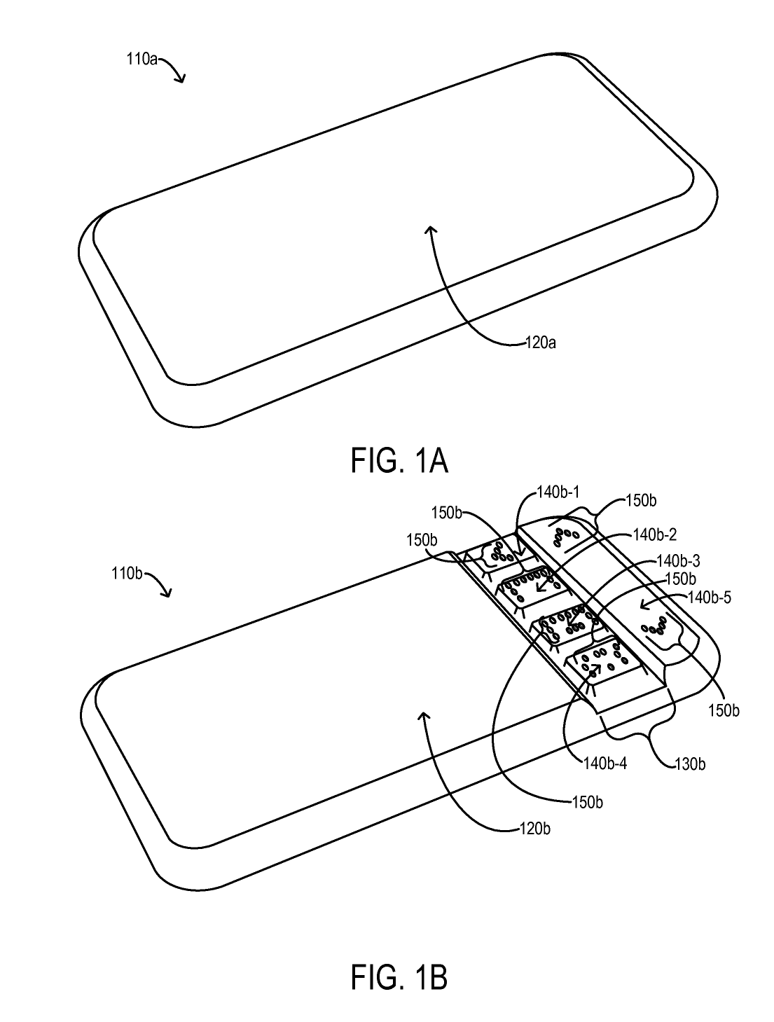

Referring first to FIG. 1A and FIG. 1B, perspective diagrams of a mobile electronic device 110a-b according to some embodiments are shown. In some embodiments, the mobile electronic device 110a-b may comprise a user and/or network device such as a cellular telephone, “smart” phone, PDA, and/or tablet computer. As depicted in FIG. 1A, the mobile electronic device 110a may comprise an interface surface 120a. In some embodiments, the interface surface 120a may comprise a deformable surface such as a surface comprising Electric Active Plastic (EAP) and/or other deformable and/or elastic materials that are or become known or practicable for use in accordance with embodiments described herein. According to some embodiments, the interface surface 120a may be acted upon by one or more actuators (not shown) positioned underneath the interface surface 120a and/or embedded within the interface surface 120a and/or mobile electronic device 110a. A matrix of actuators situated behind the interface surface 120a may, for example, be electrically-actuated to cause various desired deformations of the interface surface 120a. The mobile electronic device 110a-b may comprise, for example, a “haptiphony” device (e.g., a telephonic device comprising haptic interface technology).

In some embodiments, the interface surface 120a may be deformed, set, positioned, and/or otherwise acted upon to display and/or represent one or more images (e.g., three-dimensional images), sounds, indications of data, and/or characters such as Braille characters, and/or to indicate or define one or more regions or portions. As shown in FIG. 1B, for example, the mobile electronic device 110b (and/or the interface surface 120b) may comprise a depressed region or portion 130b, one or more raised regions or portions 140b, and/or one or more Braille characters 150b (e.g., comprising one or more identifiable actuation points or, what would be referred to with respect to a typical display device, as a pixel—here, “sensils” or “hapsils”; although not all the Braille characters 150b shown in FIG. 1B are necessarily part of the standard Braille alphabet or character set). According to some embodiments, the smooth surface of the interface surface 120a depicted in FIG. 1A may be acted upon (e.g., electrically and/or electro-mechanically) to form the depressed portion 130b (e.g., a “valley”). In some embodiments, the raised portions 140b (e.g., “buttons”, “hills”, or “hillocks”) may be defined by maintain their height and/or orientation with respect to the interface surface 120b and/or a default configuration and/or height thereof (e.g., as shown in FIG. 1B), within and/or adjacent to the valley 130b. In some embodiments, the buttons 140b may be defined, created, and/or output by raising their height and/or orientation with respect to the interface surface 120b and/or a default configuration and/or height thereof.

According to some embodiments, each button 140b may display and/or output an indication of a Braille character 150b. As shown in FIG. 1B, the Braille characters 150b may be output by a deformation, setting, and/or configuration of specific portions of the buttons 140b. A first button 140b-1 may display a left-arrow Braille character 150b and/or image via raised and/or depressed bumps on the interface surface 120b, for example, and/or a second button 140b-2 and a third button 140b-3 may utilize Braille characters 150b and/or images to represent “on” and “off” (or “start” and “end”) functions, respectively. In some embodiments, a fourth button 140b-4 may comprise Braille characters 150b reading “S”, “M”, “S”—or “SMS”—to represent a Short Message Service (SMS) and/or other “texting” functionality. According to some embodiments, a fifth button 140b-5 may comprise a scroll bar with Braille characters 150b on each end representing up and down scroll (or movement) arrows. The various example buttons 140b depicted in FIG. 1B may, in combination with the displayed Braille characters 150b for example, be utilized by a vision-impaired user to utilize and/or operate the mobile electronic device 110b as a cellular telephone.

The mobile electronic device 110a-b may, in some embodiments, include and/or comprise more elements and/or components than are depicted in FIG. 1A and/or FIG. 1B. FIG. 1A and FIG. 1B are intended to depicted example interface surfaces 120a-b of the mobile electronic device 110a-b, for example, and do not explicitly show various buttons, switches, speakers, microphones, cameras, antennae, input and/or output ports or connections, magnetic stripe and/or credit cards readers, and/or other components that may be implemented in conjunction with the mobile electronic device 110a-b without deviating from embodiments described herein. In some embodiments, the valley 130b and/or the buttons 140b may not comprise deformed and/or displaced portions of the interface surface 120a-b. Any or all of the valley 130b and/or buttons 140b (and/or attendant Braille characters 150b) may, for example, comprise fixed button, switches, and/or other devices of the mobile electronic device 110a-b (e.g., adjacent to the deformable interface surface 120a-b). According to some embodiments, fewer or more valleys 130b, buttons 140b, and/or Braille characters 150b may be utilized and/or implemented on the mobile electronic device 110a-b (and/or the interface surface 120a-b thereof). In some embodiments, the interface surface 120a-b may be planar (as shown in FIG. 1A and FIG. 1B) and/or may be curved or include curvature. According to some embodiments, for example, the interface surface 120a-b may comprise a curved surface of a mouse (not shown) or other input device and/or may comprise a sphere or portion thereof (also not shown).

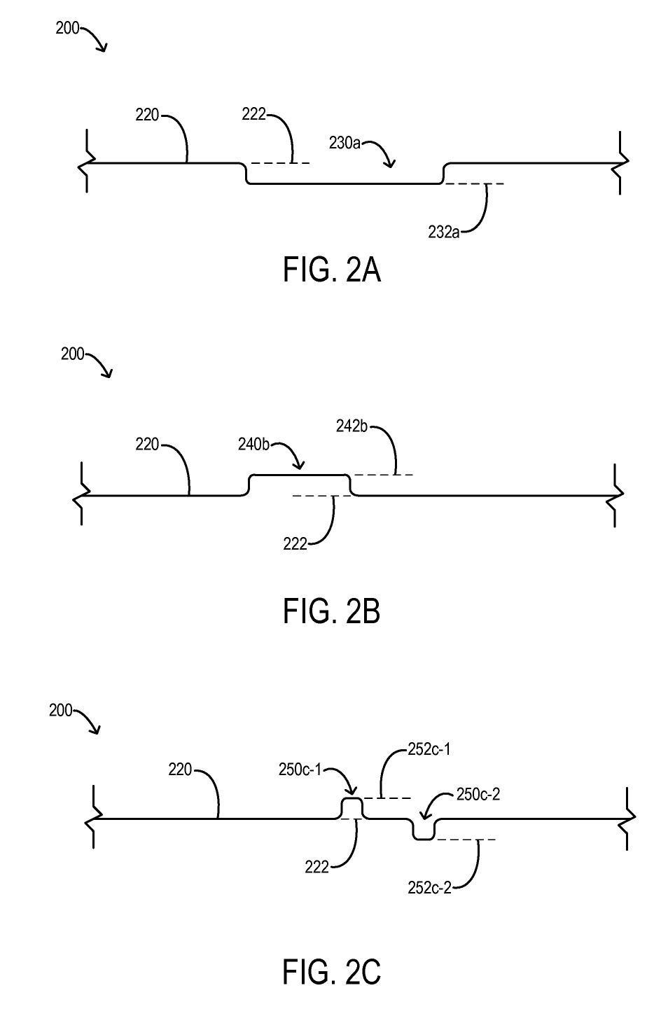

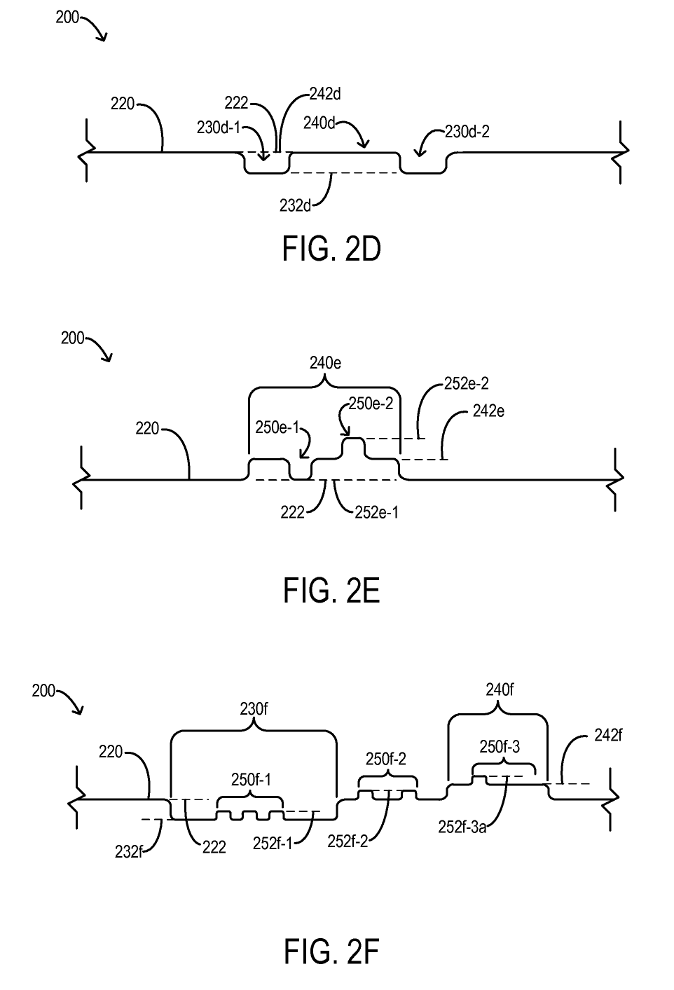

Turning to FIG. 2A, FIG. 2B, FIG. 2C, FIG. 2D, FIG. 2E, and FIG. 2F, schematic cross-section diagrams of an example interface 200 according to some embodiments are shown. In some embodiments, the interface 200 may conduct and/or facilitate visually-impaired utilization of one or more electronic, computerized, and/or electro-mechanical devices. The interface 200 may, for example, be similar in configuration and/or functionality to the mobile electronic device 110a-b (and/or one or more components thereof) of FIG. 1 herein.

In some embodiments, and referring to FIG. 2A, the interface 200 may comprise an interface surface 220. As depicted, the interface surface 220 may be situated, set, configured, and/or otherwise disposed at a default level, elevation, and/or height 222. According to some embodiments, the default height 222 may comprise a height defined by an inactive state of the interface surface 220 and/or of any actuators (not shown) coupled to act thereupon. In some embodiments, the interface 200 may comprise a valley 230 disposed at a first height and/or depth 232a. As depicted, the valley 230a may comprise a portion of the interface surface 220 which is activated and/or actuated (which may include, for example, the lessening and/or removal of force there from) to form a depression on (or within) the interface surface 220. In some embodiments as described herein, the valley 230a may be utilized as a region of the interface surface 220 upon and/or within which various information is output. The valley 230a may, for example, be utilized as a “screen” and/or “display device” for output of information to a visually-impaired user. In some embodiments, the user may utilize touch to determine the boundaries, limits, and/or extents of the valley 230a, thereby identifying an area of the interface surface 220 where specific types of information may be output.

According to some embodiments, and referring to FIG. 2B, the interface surface 220 may comprise, and/or be acted upon to include, a button 240b disposed at a second height 242b. The button 240b portion of the interface surface 220 may, for example, be acted upon by being raised above the default height 222 to define the button 240b. The button 240b may, in some embodiments, be utilized to emulate and/or act as a button, switch, toggle, and/or action or command area via which a visually-impaired user may interact with (e.g., provide commands and/or input to) a device. In some embodiments, the user may utilize touch to determine the boundaries, limits, and/or extents of the button 240b, thereby identifying an area of the interface surface 220 where specific types of functions may be performed and/or via which certain types of information may be output (e.g., a different type of information than the type of information provided by and/or in the valley 230a).

In some embodiments, and referring to FIG. 2C, the interface surface 220 may comprise, and/or be acted upon to include, a bump 250c-1 disposed at a third height 252c-1 and/or a hole 250c-2 disposed at a fourth height and/or depth 252c-2. The bump 250c-1 and/or the hole 250c-2 may, for example, comprise regions, portions, and/or individual pixels of the interface surface 220 that may be acted upon by being raised above, or lowered below, the default height 222. In some embodiments, the bump 250c-1 and/or the hole 250c-2 may comprise and/or define one or more Braille characters and/or other images, shapes, or data. One or more bumps 250c-1 and/or the holes 250c-2 may be activated on the interface surface 220, for example, to convey letters, words, sentences, and/or other informational items to a user of the interface 200.

According to some embodiments, and referring to FIG. 2D, the interface surface 220 may comprise, and/or be acted upon to include, a first valley 230d-1, a second valley 230d-2, and/or a button 240d. In some embodiments, the first valley 230d-1 and/or the second valley 230d-2 may be disposed at a fifth height and/or depth 232d. In some embodiments, the button 240d may be disposed at a sixth height 242d. As depicted in FIG. 2D, the first valley 230d-1 and the second valley 230d-2 may create and/or define the button 240d. The sixth height 242d of the button 240d may, for example, be the same as the default height 222. In the case that only two variable heights/depths are possible and/or desired for the interface surface 220, for example, the button 240d may be conveyed (e.g., output and/or defined) to a user by utilization of the first valley 230d-1 and the second valley 230d-2 to create a distinct area of the interface surface 220 that is identifiable and/or distinguishable as the button 240d. According to some embodiments, the button 240d may be associated with a particular command and/or function that may be initiated, called, and/or executed by the button 240d receiving touch input from a user (e.g., a user may “press” the button 240d). According to some embodiments, the button 240d may deflect and/or otherwise change height in response to a receipt of touch input. In such a manner, for example, a user may receive a tactile response from the button 240d as an indication that the “press” of the button 240d was successful (e.g., received).

In some embodiments, and referring to FIG. 2E, the interface surface 220 may comprise, and/or be acted upon to include, a button 240e. According to some embodiments, the button 240e and/or the interface surface 220 may comprise a hole 250e-1 and/or a bump 250e-2. In some embodiments, the button 240e may be disposed at a seventh height 242e. In some embodiments, the hole 250e-1 may be disposed at an eighth height and/or depth 252e-1 and/or the bump 250e-2 may be disposed at a ninth height 252e-2. According to some embodiments, such as depicted in FIG. 2E, the seventh height 242e and the eighth depth 252e-1 may be of the same magnitude. In such an embodiment, the eighth depth 252e-1 may be coincident with the default height 222. The hole 250e-1 and/or the bump 250e-2 may, in some embodiments, be utilized to output one or more Braille characters via the button 240e. The hole 250e-1 and/or the bump 250e-2 may, for example, represent a label and/or title descriptive of the functionality of the button 240e. In such a manner, a user may sense, via the hole 250e-1 and/or the bump 250e-2, the purpose of the button 240e an may accordingly decide whether to activate or press the button 240e. In some embodiments, by being output in association with (e.g., on and/or in) the button 240e, the hole 250e-1 and/or the bump 250e-2 may indicate Braille characters of a specific purpose, function, and/or type (e.g., a label for an executable button 240e).

According to some embodiments, and referring to FIG. 2F, the interface surface 220 may comprise, and/or be acted upon to include, a valley 230f and/or a button 240f. In some embodiments, the valley 230f may be disposed at a tenth height and/or depth 232f and/or the button 240f may be disposed at an eleventh height 242f. In such a manner, for example, three (3) distinguishable regions and/or portions of the interface surface 220 may be defined. A first region may comprise the portion of the interface surface 220 that is disposed at the default height 222 (and/or that is situated between the valley 230f and the button 240f), a second region may comprise the portion of the interface surface 220 disposed at the tenth height 232f as part of the valley 230f, and/or the third region may comprise the portion of the interface surface 220 disposed at the eleventh height 242f as part of the button 240f. In some embodiments, data of different types, purposes, and/or functionality may be output in, on, and/or utilizing the three distinguishable regions and/or portions of the interface surface 220. As depicted in FIG. 2F, for example, a first Braille character 250f-1 may be output in the second region (i.e., in the valley 230f), a second Braille character 250f-2 may be output in the first region (i.e., on the interface surface 220 between the valley 230f and the button 240f), and/or a third Braille character 250f-3 may be output in the third region (i.e., on the button 240f).

In some embodiments, the positioning of the first Braille character 250f-1 in the second region (i.e., in the valley 230f) may identify the first Braille character 250f-1 as text output and or editable-text and/or data such as the text of an e-mail, SMS message, etc. Such positioning may also or alternatively identify the valley 230f as a text-field. According to some embodiments, the positioning of the second Braille character 250f-2 in the first region (i.e., on the interface surface 220 between the valley 230f and the button 240f) may identify the second Braille character 250f-2 as an informational item such as non-interactive and/or non-editable output (e.g., a time or date associated with an e-mail, SMS message, etc., which itself is displayed via the text-field valley 230f). According to some embodiments, the positioning of the third Braille character 250f-3 in the third region (i.e., on the button 240f) may identify the third Braille character 250f-3 as a command, function, and/or other action.

According to some embodiments, the first Braille character 250f-1 may be disposed at a twelfth height 252f-1, the second Braille character 250f-2 may be disposed at a thirteenth height 252f-2, and/or the third Braille character 250f-3 may be disposed at a fourteenth height 252f-3. As shown in FIG. 2F, for example, the twelfth height 252f-1, the thirteenth height 252f-2, and the fourteenth height 252f-3 may comprise heights of smaller magnitude and/or displacement than the tenth height 232f and/or the eleventh height 242f. In such a manner, for example, the Braille characters 250f may be more easily distinguishable from other features and/or output of the interface surface 220 (such as the valley 230f and/or the button 240f).

In some embodiments, any or all of the various heights 222, 232, 242, 252 described in conjunction with FIG. 2A, FIG. 2B, FIG. 2C, FIG. 2D, FIG. 2E, and FIG. 2F herein may be different or the same, as is or becomes desirable and/or practicable. Fewer or more components 220, 222, 230, 232, 240, 242, 250, 252 and/or various configurations of the depicted components 220, 222, 230, 232, 240, 242, 250, 252 may be included in the interface 200 without deviating from the scope of embodiments described herein. In some embodiments, the components 220, 222, 230, 232, 240, 242, 250, 252 may be similar in configuration and/or functionality to similarly named and/or numbered components as described herein.

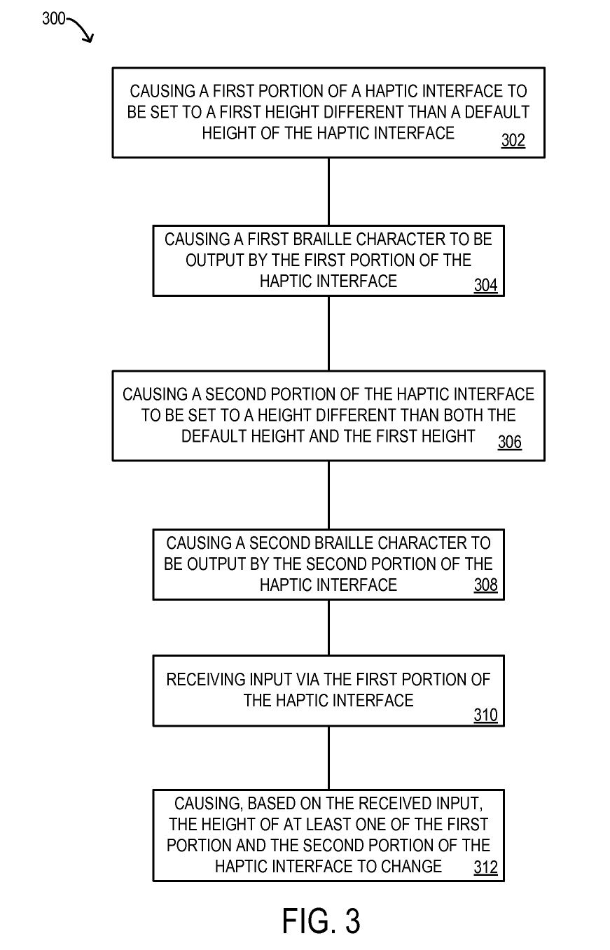

Turning to FIG. 3, a flow diagram of a method 300 according to some embodiments is shown. In some embodiments, the method 300 may be performed and/or implemented by and/or otherwise associated with one or more specialized and/or computerized processing devices (e.g., the mobile electronic device 110a-b of FIG. 1), specialized computers, computer terminals, computer servers, computer systems and/or networks, and/or any combinations thereof. In some embodiments, the method 300 may be embodied in, facilitated by, and/or otherwise associated with various input mechanisms and/or interfaces such as the example interfaces 200 described with respect to FIG. 2 herein. The process and/or flow diagrams described herein do not necessarily imply a fixed order to any depicted actions, steps, and/or procedures, and embodiments may generally be performed in any order that is practicable unless otherwise and specifically noted. Any of the processes and/or methods described herein may be performed and/or facilitated by hardware, software (including microcode), firmware, or any combination thereof. For example, a storage medium (e.g., a hard disk, Universal Serial Bus (USB) mass storage device, and/or Digital Video Disk (DVD)) may store thereon instructions that when executed by a machine (such as a computerized processing device) result in performance according to any one or more of the embodiments described herein.

In some embodiments, the method 300 may comprise causing (e.g., by a specially-programmed computerized processing device) a first portion of a haptic interface to be set to a first height different than a default interface height of the haptic interface, at 302. A signal may be sent, for example, from a processing device to one or more actuators, the signal causing the one or more actuators to become activated. In some embodiments, the one or more actuators may be set and/or activated to one of a plurality of possible heights, depths, and/or configurations. Based on desired information (and/or type of information thereof) to be output, for example, a desired magnitude of the first height may be determined and an appropriate signal and/or command sent to (and received by) a device operable to cause the haptic interface to change height in accordance with the desired magnitude (and/or at or including certain specified locations on and/or portions of the haptic interface).

According to some embodiments, the method 300 may comprise causing (e.g., by the specially-programmed computerized processing device), while the first portion of the haptic interface is set to the first height, a first Braille character to be output by the first portion of the haptic interface, at 304. The first portion of the interface may define and/or identify, for example, a specific type of area on and/or of the haptic interface such as text-field, an informational area, and/or an action area, as described herein. Output of one or more Braille characters, such as the first Braille character, on, in, and/or via the first portion of the haptic interface, may accordingly associated the first Braille character with the purpose, type, and/or functionality of the first portion of the haptic interface. In such a manner, for example, Braille characters may be utilized in conjunction with specifically actuated portions of the haptic interface to provide various types of information in a more efficient and intuitive way than typical haptic interfaces.

In some embodiments, the method 300 may comprise causing (e.g., by the specially-programmed computerized processing device a second portion of the haptic interface to be set to a second height different than both the default interface height of the haptic interface and the first height, at 306. While the first portion of the haptic interface may be designated as a text-field and the first Braille character may comprise editable text therein, for example, the second portion of the haptic interface may be designated as an action field and/or button. In some embodiments, the first height may comprise a height lower than the default height, defining the text-field for example, while the second height may comprise a height higher than the default height, defining the action button. In some embodiments, the magnitudes of the first height and the second height may be the same. In some embodiments, the magnitudes of the first and second heights may be expressed and/or actuated in opposite directions.

According to some embodiments, the method 300 may comprise causing (e.g., by the specially-programmed computerized processing device), while the second portion of the haptic interface is set to the second height, a second Braille character to be output by the second portion of the haptic interface, at 308. In the case that the second portion of the haptic interface is set to the second height by a plurality of actuators being activated, for example, a subset of the plurality of actuators may be deactivated and/or activated in a different manner to cause an outputting of the second Braille character. In some embodiments, the second Braille character may comprise the same character and/or symbol as the first Braille character. According to some embodiments, even of the two Braille characters are the same, they may have different meaning and/or effect based on their different and/or separate locations (e.g., on and/or in the first portion and the second portion of the haptic interface, respectively).

In some embodiments, the method 300 may comprise receiving input by the first portion of the haptic interface, at 310. The haptic interface may, for example, comprise and/or be coupled to a touch-sensitive input device such as TouchCell™ field-effect input device available from TouchSensor Technologies, LLC of Wheaton, Ill. The touch-sensitive input device may, according to some embodiments, detect field-effect disturbance such as a human finger, a stylus, etc. In some embodiments, the location on the haptic interface where the touch input is received may be determined. In some embodiments, the input may be received by a physical movement of one or more actuators of the first a portion of the haptic interface (such as any actuators associated with the first Braille character) in response to force applied by a user (e.g., a “push” with a finger). In the case that the one or more actuators comprise mechanically-displaceable objects, for example, a displacement of such objects in response to user input may comprise an indication of the user input. In some embodiments, the input may be received and/or defined by one or more gestures and/or other input actions undertaken by a user of the haptic interface. Multi-touch technology (e.g., via plural-point awareness) such as Bending Wave Touch (BWT), Dispersive Signal Touch (DST), Near Field Imaging (NFI), Projected Capacitive Touch (PST), Surface Capacitive Touch (SCT), and/or Surface Acoustic Wave Touch (SAW) may, for example, by utilized by and/or in conjunction with the haptic interface to receive and/or interpret user gestures.

According to some embodiments, the method 300 may comprise causing (e.g., by the specially-programmed computerized processing device), based on the received input, the first portion of the haptic interface to change height, at 312. The input may, for example, comprise a command to edit text in a text field, such as a command to edit the first Braille character in the first portion of the haptic interface. In response to such a command, the first Braille character may be altered as instructed (e.g., deleted, moved, and/or changed to a different character), such as by lowering and/or raising of actuators and/or areas associated with the first Braille character. In such a manner, the first portion of the haptic interface changes height (at least in part). In some embodiments, such as in the case that the received input comprises a function command (e.g., and the first portion of the haptic interface comprises an action button), the haptic interface may be switched to a different mode. In such an embodiment, the first portion of the haptic interface may no longer be needed as a text-field, button, or the like, and may accordingly be changed (e.g., in height) to reflect and/or be in accordance with any new functionality, type, and/or purpose. In some embodiments, a subset of the first portion may change height in response to the received input (e.g., in accordance with stored instructions).

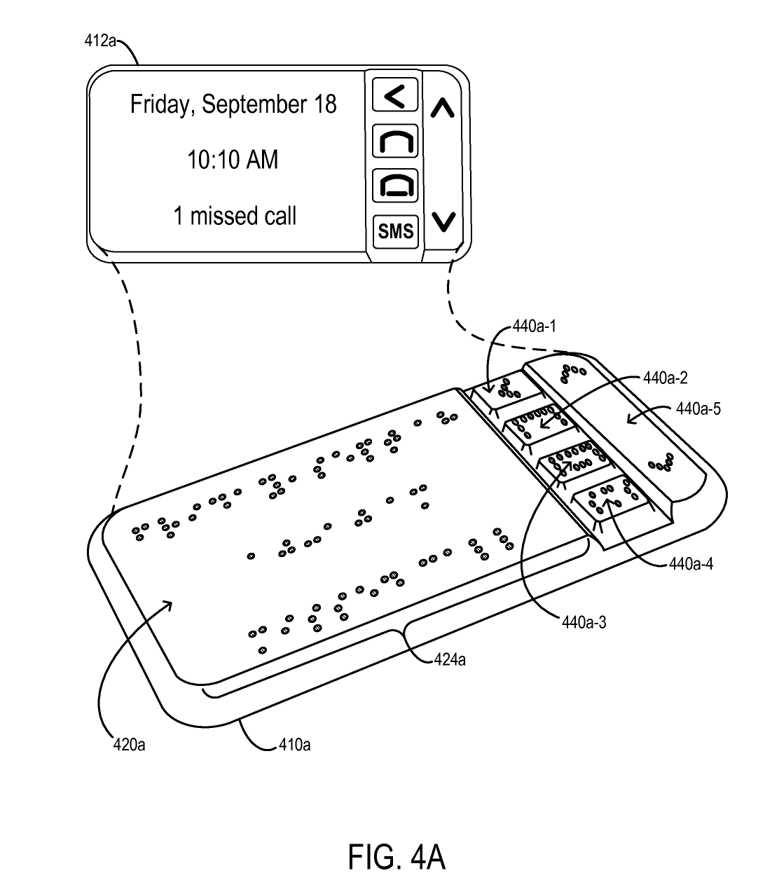

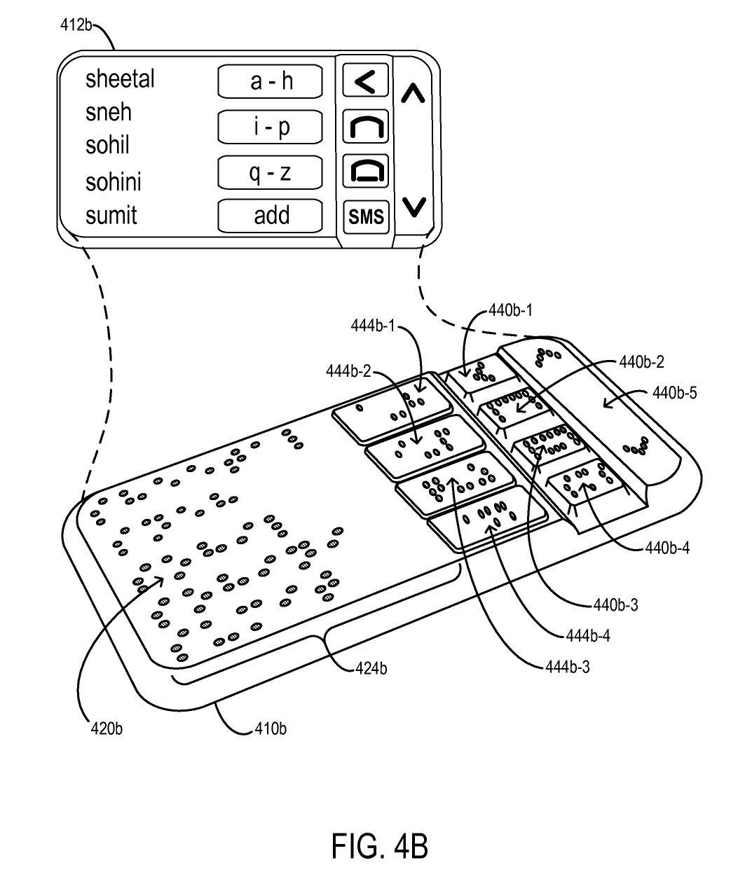

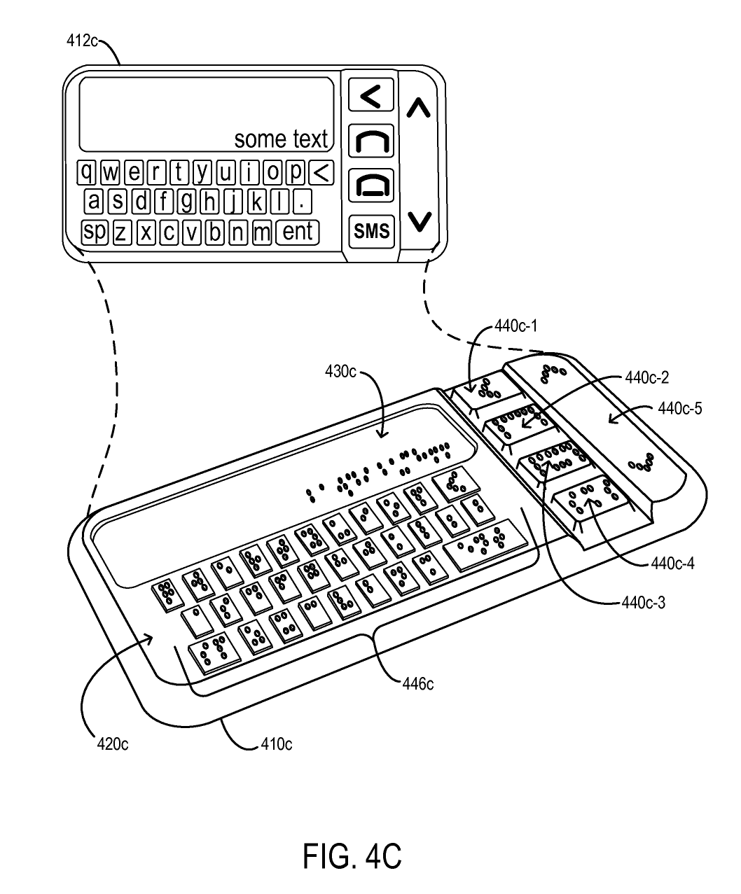

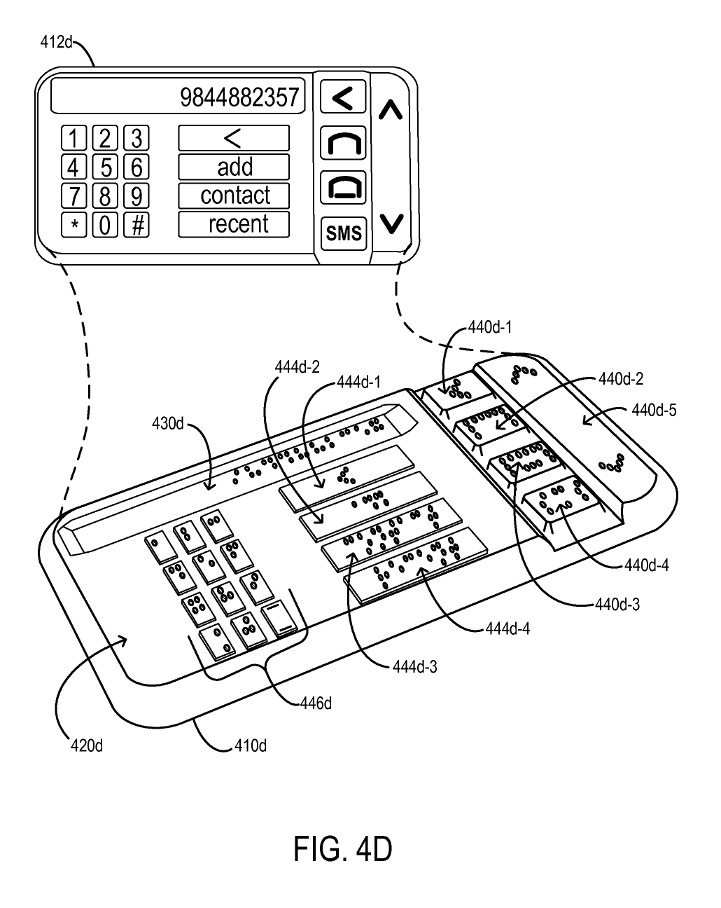

Turning now to FIG. 4A, FIG. 4B, FIG. 4C, and FIG. 4D, example mobile electronic devices 410 according to some embodiments are shown. In some embodiments, the example mobile electronic devices 410 may be similar in configuration and/or functionality to the mobile electronic device 110a-b of FIG. 1. The mobile electronic devices 410 may, for example, comprise cellular telephones and/or other “smart” communication devices such as an iPhone® manufactured by Apple®, Inc. of Cupertino, Calif. or Optimus™ S smart phones manufactured by LG® Electronics, Inc. of San Diego, Calif., and running the Androird® operating system from Google®, Inc. of Mountain View, Calif.

According to some embodiments, and referring specifically to FIG. 4A, the mobile electronic device 410a may comprise a Braille-phone. The configuration of the mobile electronic device 410a may be represented by a plan-view 412a showing the Braille characters converted into conventional English text, for illustrative purposes only. In some embodiments, the mobile electronic device 410a may comprise an interface surface 420a, a first portion 424a, and/or a plurality of buttons 440a. The plurality of buttons 440a may, according to some embodiments, be formed and/or defined by actuating and/or deforming respective portions of the interface surface 420a (e.g., portions other than the first portion 424a). Electric current may be passed through and/or to one or more specific actuators and/or actuator areas beneath and/or within the interface surface 420a, for example, causing a piezoelectric reaction that deforms, displaces, and/or otherwise moves or acts upon the interface surface 420a to cause an outputting of the plurality of buttons 440a, as depicted. In some embodiments, the plurality of buttons 440a portions of the mobile electronic device 410a.

As depicted in FIG. 4A, a first button 440a-1 may comprise a left-arrow button, represented by a Braille image of the left-arrow on the interface surface 420a. A second button 440a-2 may comprise an “on” and/or “start” button and/or a third button 440a-3 may comprise an “off” and/or “end” button, each represented by a Braille image of the respective button-function icon. In some embodiments, a fourth button 440a-4 may comprise an “SMS” button (represented by the Braille alphabet characters “S”, “M”, and “S”) and/or a fifth button 440a-5 may comprise a scroll-bar and/or slider button represented by Braille images of up and down arrows at each end of the scroll-bar. In some embodiments, the first portion 424a may be set to and/or disposed at a default elevation of the interface surface 420a, such as the default elevation or height 222 of FIG. 2A, FIG. 2B, FIG. 2C, FIG. 2D, FIG. 2E, and FIG. 2F. Braille characters displayed via the first portion 424a may, being associated with the first portion 424a and/or the respective height and/or orientation thereof, for example, may be identifiable and/or distinguishable as non-editable informational data. In the example of FIG. 4A, the non-editable text displayed via the first portion 424a is descriptive of a missed telephone call (e.g., time, date, and quantity thereof).

In some embodiments, such as depicted in FIG. 4A, the surfaces of the buttons 440a may also be set to and/or disposed at the default height. The change in height defining and/or distinguishing the buttons 440a, however, may cause the buttons 440a to be distinguishable from the first portion 424a. Braille characters output via the buttons 440a may, accordingly, be identifiable and/or distinguishable as functional, command, and/or action items. A user may feel the surface of the mobile electronic device 410a, for example, to distinguish between the first portion 424a and the various buttons 440a. The user may similarly feel the respective Braille characters output thereon to determine the respective functions that will be executed upon selection and/or activation of each respective button 440a.

According to some embodiments, and turning specifically to FIG. 4B for example, the interface 410b may comprise a plan-view 412b, for illustrative purposes, an interface surface 420b, a first portion 424b, and/or a plurality of buttons 440b. In some embodiments, and similar to the configuration illustrated in FIG. 4A, the interface 410b may comprise a first button 440b-1 that may comprise a left-arrow button, represented by a Braille image of the left-arrow on the interface surface 420b. A second button 440b-2 may comprise an “on” and/or “start” button and/or a third button 440b-3 may comprise an “off” and/or “end” button, each represented by a Braille image of the respective button-function icon. In some embodiments, a fourth button 440b-4 may comprise an “SMS” button (represented by the Braille alphabet characters “S”, “M”, and “S”) and/or a fifth button 440b-5 may comprise a scroll-bar and/or slider button represented by Braille images of up and down arrows at each end of the scroll-bar.

According to some embodiments, the interface 410b may also or alternatively comprise (e.g., as illustrated in FIG. 4B) a plurality of special function buttons 444b. While, in some embodiments, the buttons 440a may be associated with general and/or global functionality that is capable of being utilized across multiple configurations and/or modes of the interface 410b, for example, the special function buttons 444b may be associated with functionality specific to one or more tasks, modes, configurations, and/or uses of the interface 410b. In the example of FIG. 4B, first, second, and third special function buttons 444b-1, 444b-2, 444b-3 may comprise alphabet range selections, such as for browsing through and/or selecting or identifying contacts (e.g., “friends”). A fourth special function button 444b-4 may comprise an “add” button, such as may be utilized to add a selected contact to an e-mail. In some embodiments, the special function buttons 444b may be set to and/or disposed at a height higher than the default surface of the interface surface 420b. In such a manner, for example, not only are the special function buttons 444b easily distinguishable from the first portion 424a, but from the “global” buttons 440b as well.

In some embodiments, the first portion 424b may be set to and/or disposed at a default elevation of the interface surface 420b, such as the default elevation or height 222 of FIG. 2A, FIG. 2B, FIG. 2C, FIG. 2D, FIG. 2E, and FIG. 2F. Braille characters displayed via the first portion 424b may, being associated with the first portion 424b and/or the respective height and/or orientation thereof, for example, may be identifiable and/or distinguishable as non-editable informational data. In the example of FIG. 4B, the non-editable text displayed via the first portion 424b is descriptive of a list of contact and/or friends.

According to some embodiments, and turning specifically to FIG. 4C, the interface 410c may comprise a plan-view 412c, for illustrative purposes, an interface surface 420c, a text-box region 430c, a plurality of buttons 440c, and/or a keyboard 446c. In some embodiments, and similar to the configuration illustrated in FIG. 4A and/or FIG. 4B, the interface 410c may comprise a first button 440c-1 that may comprise a left-arrow button, represented by a Braille image of the left-arrow on the interface surface 420c. A second button 440c-2 may comprise an “on” and/or “start” button and/or a third button 440c-3 may comprise an “off” and/or “end” button, each represented by a Braille image of the respective button-function icon. In some embodiments, a fourth button 440c-4 may comprise an “SMS” button (represented by the Braille alphabet characters “S”, “M”, and “S”) and/or a fifth button 440c-5 may comprise a scroll-bar and/or slider button represented by Braille images of up and down arrows at each end of the scroll-bar.

In some embodiments, the text-box region 430c may be set to and/or disposed at a height lower than the default height of the interface surface 420c. In such a manner, for example, a user touching the screen will be able to easily and quickly distinguish the text-box region 430c as a separate region of the interface surface 420c and/or determine that any Braille characters (e.g., “text”) displayed in the text-box region 430c comprises editable text. The text-box region 430c may be utilized, for example, to type, input, and/or enter a text message and/or e-mail text. In some embodiments, text in the text-box region 430c may be directly editable by touch—such as in the case that the mobile electronic device 410c comprises touch-sensitive input capabilities (e.g., on and/or coupled to the interface surface 420c). According to some embodiments, the text in the text-box region 430c may be edited, and/or new text may be entered, via the keyboard 446c. The keyboard 446c may, as depicted in FIG. 4C, comprise a plurality of input keys defined by being set and/or disposed at a height above the default height of the interface surface 420c.

In some embodiments, and turning specifically to FIG. 4D, the interface 410d may comprise a plan-view 412d, for illustrative purposes, an interface surface 420d, a text-box region 430d, a plurality of global buttons 440d, a plurality of special function buttons 444d, and/or a keypad 446d. In some embodiments, and similar to the configurations illustrated in FIG. 4A, FIG. 4B, and/or FIG. 4C, the interface 410d may comprise a first button 440d-1 that may comprise a left-arrow button, represented by a Braille image of the left-arrow on the interface surface 420d. A second button 440d-2 may comprise an “on” and/or “start” button and/or a third button 440d-3 may comprise an “off” and/or “end” button, each represented by a Braille image of the respective button-function icon. In some embodiments, a fourth button 440d-4 may comprise an “SMS” button (represented by the Braille alphabet characters “S”, “M”, and “S”) and/or a fifth button 440d-5 may comprise a scroll-bar and/or slider button represented by Braille images of up and down arrows at each end of the scroll-bar.

According to some embodiments, the example configuration of the interface surface 420d (and/or of the mobile electronic device 410d) depicted in FIG. 4D may be utilized to facilitate a telephone call (e.g., voice communications). The keypad 446d may be distinguished as an action area (e.g., having a plurality of separate action areas therein, one for each number or character on the keypad 446d) by being disposed at a height higher than the default height of the interface surface 420d, for example, and may be utilized to enter and/or edit text (e.g., numerals) in the text-box region 430d. In some embodiments, a user may utilize a first special function button 444d-1 to delete and/or remove characters from the text-box region 430d. The user may also or alternatively utilize a second special function button 444d-2 to add a selected contact to the current phone call (e.g., by selecting a desired contact and having their number automatically populated in the text-box region 430d), utilize a third special function button 444d-3 to select the desired contact (and/or to “go to” or switch to a “contacts” screen or mode of the interface surface 420d—e.g., the “contact” mode depicted in FIG. 4B herein), and/or utilize a fourth special function button 444d-4 to go to and/or add contacts and/or numbers from a list of recent calls, contacts, etc.

While the example interfaces 410a-d are depicted herein with respect to specific examples of layouts, configurations, and/or functionality, other layouts, configurations, and/or functionalities may be implemented without deviating from the scope of embodiments described herein. Similarly, while specific examples of functionalities being associated with specific heights and/or surface textures or orientations of the interface surfaces 420a-d are described, fewer, more, and/or different associations may be utilized as is or becomes desirable and/or practicable. Fewer or more components 420a-d, 424a-b, 430c-d, 440a-d, 444b, 444d, 446c-d and/or various configurations of the depicted components 420a-d, 424a-b, 430c-d, 440a-d, 444b, 444d, 446c-d may be included in the mobile electronic devices 410a-d without deviating from the scope of embodiments described herein. In some embodiments, the components 420a-d, 424a-b, 430c-d, 440a-d, 444b, 444d, 446c-d may be similar in configuration and/or functionality to similarly named and/or numbered components as described herein.

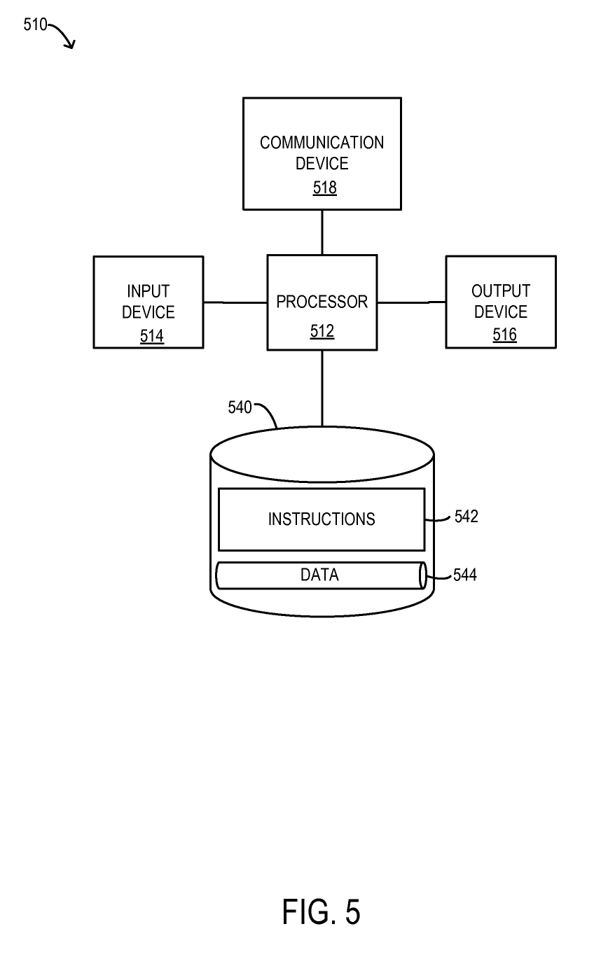

Turning to FIG. 5, a block diagram of an apparatus 500 according to some embodiments is shown. In some embodiments, the apparatus 500 may be similar in configuration and/or functionality to the mobile electronic devices 110a-b, 410a-d of FIG. 1A, FIG. 1B, FIG. 2A, FIG. 2B, FIG. 2C, FIG. 2D, FIG. 2E, and/or FIG. 2F herein. The apparatus 500 may, for example, execute, process, facilitate, and/or otherwise be associated with the method 300 of FIG. 3 herein. In some embodiments, the apparatus 500 may comprise an electronic processor 512, an input device 514, an output device 516, a communication device 518, and/or a memory device 540. Fewer or more components 512, 514, 516, 518, 540 and/or various configurations of the components 512, 514, 516, 518, 540 may be included in the apparatus 500 without deviating from the scope of embodiments described herein.

According to some embodiments, the electronic processor 512 may be or include any type, quantity, and/or configuration of electronic and/or computerized processor that is or becomes known. The electronic processor 512 may comprise, for example, an Intel® IXP 2800 network processor or an Intel® XEON™ Processor coupled with an Intel® E7501 chipset. In some embodiments, the electronic processor 512 may comprise multiple inter-connected processors, microprocessors, and/or micro-engines. According to some embodiments, the electronic processor 512 (and/or the apparatus 500 and/or other components thereof) may be supplied power via a power supply (not shown) such as a battery, an Alternating Current (AC) source, a Direct Current (DC) source, an AC/DC adapter, solar cells, and/or an inertial generator. In some embodiments, such as in the case that the apparatus 500 comprises a server such as a blade server, necessary power may be supplied via a standard AC outlet, power strip, surge protector, and/or Uninterruptible Power Supply (UPS) device. In some embodiments, such as in the case that the apparatus 500 comprises a mobile electronic device such as a cellular telephone, necessary power may be supplied via a Nickel-Cadmium (Ni-Cad) and/or Lithium-Ion (Li-ion) battery device.

In some embodiments, the input device 514 and/or the output device 516 are communicatively coupled to the electronic processor 512 (e.g., via wired and/or wireless connections, traces, and/or pathways) and they may generally comprise any types or configurations of input and output components and/or devices that are or become known, respectively. The input device 514 may comprise, for example, a keyboard that allows an operator of the apparatus 500 to interface with the apparatus 500 (e.g., such as via an improved haptic interface as described herein). The output device 516 may, according to some embodiments, comprise a display screen and/or other practicable output component and/or device. The output device 516 may, for example, provide data to a user via a haptic display and/or utilizing surface actuation as described herein. According to some embodiments, the input device 514 and/or the output device 516 may comprise and/or be embodied in a single device such as a touch-screen haptic interface.

In some embodiments, the communication device 518 may comprise any type or configuration of communication device that is or becomes known or practicable. The communication device 518 may, for example, comprise a Network Interface Card (NIC), a telephonic device, a cellular network device, a router, a hub, a modem, and/or a communications port or cable. In some embodiments, the communication device 518 may be coupled to provide data to a remote user device, such as in the case that the apparatus 500 is utilized to conduct and/or facilitate remote communications between as user of the apparatus 500 and a remote user of the remote user device (e.g., voice calls, text-messages, and/or Social Networking posts, updates, “check-in”, and/or other communications). According to some embodiments, the communication device 518 may also or alternatively be coupled to the electronic processor 512. In some embodiments, the communication device 518 may comprise an IR, RF, Bluetooth™, and/or Wi-Fi® network device coupled to facilitate communications between the electronic processor 512 and another device.

The memory device 540 may comprise any appropriate information storage device that is or becomes known or available, including, but not limited to, units and/or combinations of magnetic storage devices (e.g., a hard disk drive), optical storage devices, and/or semiconductor memory devices such as Random Access Memory (RAM) devices, Read Only Memory (ROM) devices, Single Data Rate Random Access Memory (SDR-RAM), Double Data Rate Random Access Memory (DDR-RAM), and/or Programmable Read Only Memory (PROM). The memory device 540 may, according to some embodiments, store instructions 542. In some embodiments, the instructions 542 may be utilized by the electronic processor 512 to provide output information via the output device 516 and/or the communication device 518 (e.g., the causing of the haptic interface height settings at 302, 306, 312 and/or the causing of the outputting of the Braille characters at 304, 307, of the method 300 of FIG. 3).

According to some embodiments, the instructions 542 may be operable to cause the electronic processor 512 to access data 544, stored by the memory device 540. Data 544 received via the input device 514 and/or the communication device 518 may, for example, be analyzed, sorted, filtered, decoded, decompressed, ranked, scored, plotted, and/or otherwise processed by the electronic processor 512 in accordance with the instructions 542. In some embodiments, data 544 may be fed by the electronic processor 512 through one or more mathematical and/or statistical formulas, rule sets, policies, and/or models in accordance with the instructions 542 to determine one or more actuation heights, one or more haptic interface surface portions, and/or one or more modes and/or configurations that should be utilized to provide output to a user.

Any or all of the exemplary instructions and data types described herein and other practicable types of data may be stored in any number, type, and/or configuration of memory devices that is or becomes known. The memory device 540 may, for example, comprise one or more data tables or files, databases, table spaces, registers, and/or other storage structures. In some embodiments, multiple databases and/or storage structures (and/or multiple memory devices 540) may be utilized to store information associated with the apparatus 500. According to some embodiments, the memory device 540 may be incorporated into and/or otherwise coupled to the apparatus 500 (e.g., as shown) or may simply be accessible to the apparatus 500 (e.g., externally located and/or situated).

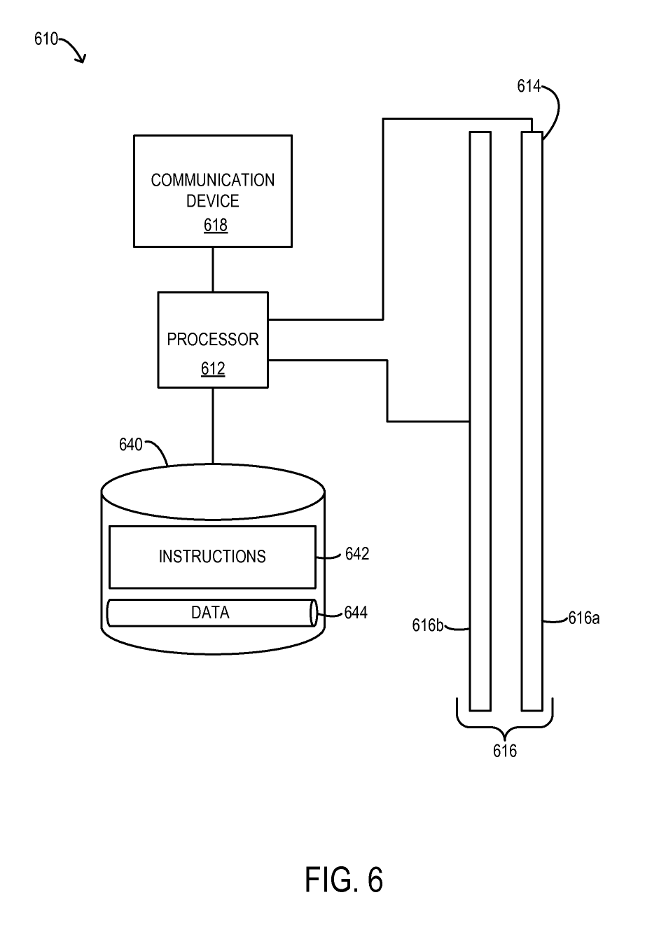

Referring now to FIG. 6, a block diagram of an apparatus 600 according to some embodiments is shown. In some embodiments, the apparatus 600 may be similar in configuration and/or functionality to the apparatus 500 of FIG. 5 and/or to the mobile electronic devices 110a-b, 410a-d of FIG. 1A, FIG. 1B, FIG. 2A, FIG. 2B, FIG. 2C, FIG. 2D, FIG. 2E, and/or FIG. 2F herein. The apparatus 600 may, for example, execute, process, facilitate, and/or otherwise be associated with the method 300 of FIG. 3 herein. In some embodiments, the apparatus 600 may comprise an electronic processor 612, an input device 614, an output device 616 (which may include, for example an elastic surface 616a and/or an actuator device 616b), a communication device 618, and/or a memory device 640 (e.g., storing instructions 642 and/or data 644). Fewer or more components 612, 614, 616, 618, 640 and/or various configurations of the components 612, 614, 616, 618, 640 may be included in the apparatus 600 without deviating from the scope of embodiments described herein. In some embodiments, the components 612, 614, 616, 618, 640 may be similar in configuration and/or functionality to similarly named and/or numbered components as described herein.

According to some embodiments, the input device 614 may comprise a touch-sensitive device such as a device capable of detecting electric and/or magnetic field disturbances (e.g., caused by insertion of a human finger, stylus, etc., into an electric and/or magnetic field created by and/or associated with the input device 614). In some embodiments, the input device 614 may comprise a thin-film device coupled to and/or incorporated into the elastic surface 616a. In some embodiments, the input device 614 may comprise the elastic surface 616a. The input device 614 may generally receive indications of input (e.g., touch input from a user) and transmit indications of such input to the electronic processor 612. In some embodiments, the electronic processor 612 may receive the indication of input from the input device 614 (e.g., the receiving at 310 of the method 300 of FIG. 3) and/or may execute the stored instructions 642 in response thereto (e.g., the causing of the change in height at 312 of the method 300 of FIG. 3). In some embodiments, such as in the case that the received input comprises a command such as a “send text message” command (e.g., the input results from an activation and/or selection of the second (or “send”) button 440c-2 of the mobile electronic device 410c of FIG. 4C), the electronic processor 612 may cause the communication device 618 to send some or all of the data 644 to a remote device (e.g., another user's cellular telephone).

In some embodiments, the electronic processor 612 may execute the stored instructions 642 (which may, for example, be specially-programmed to cause execution of the method 300 of FIG. 3 and/or any portion thereof) such as to set a height, depth, surface texture, orientation, and/or other configuration of the output device 616. The electronic processor 612 may, for example, send a signal to the actuator device 616b that causes the actuator device 616b to apply a force to, remove a force from, and/or otherwise cause a controlled movement of the elastic surface 616b (and/or a portion thereof). The actuator device 616b may be physically and/or electrically coupled, in accordance with some embodiments, such that an activation of the actuator device 616b (and/or a portion thereof) is operable to cause a displacement, movement, and/or distortion of the elastic interface 616a (and/or a portion thereof). The electronic processor 612 may cause the actuator device 616b to act upon the elastic surface 616a, for example, to cause one or more Braille characters to be output via the elastic surface 616a (e.g., the causing at 304, 308 of the method 300 of FIG. 3) and/or to cause one or more portions of the elastic surface 616a to form identifiable and/or distinguishable regions of different heights and/or textures or orientations (e.g., the causing at 302, 306 of the method 300 of FIG. 3), providing an improved haptic interface as described herein.

IV. Rules of Interpretation

Numerous embodiments are described in this patent application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

The present disclosure is neither a literal description of all embodiments of the invention nor a listing of features of the invention that must be present in all embodiments.

Neither the Title (set forth at the beginning of the first page of this patent application) nor the Abstract (set forth at the end of this patent application) is to be taken as limiting in any way the scope of the disclosed invention(s).

The term “product” means any machine, manufacture and/or composition of matter as contemplated by 35 U.S.C. §101, unless expressly specified otherwise.

The terms “an embodiment”, “embodiment”, “embodiments”, “the embodiment”, “the embodiments”, “one or more embodiments”, “some embodiments”, “one embodiment” and the like mean “one or more (but not all) disclosed embodiments”, unless expressly specified otherwise.

A reference to “another embodiment” in describing an embodiment does not imply that the referenced embodiment is mutually exclusive with another embodiment (e.g., an embodiment described before the referenced embodiment), unless expressly specified otherwise.

The terms “including”, “comprising” and variations thereof mean “including but not limited to”, unless expressly specified otherwise.

The terms “a”, “an” and “the” mean “one or more”, unless expressly specified otherwise.

The term “plurality” means “two or more”, unless expressly specified otherwise.

The term “herein” means “in the present application, including the specification, its claims and figures, and anything which may be incorporated by reference”, unless expressly specified otherwise.

The phrase “at least one of”, when such phrase modifies a plurality of things (such as an enumerated list of things) means any combination of one or more of those things, unless expressly specified otherwise. For example, the phrase at least one of a widget, a car and a wheel means (i) a widget, (ii) a car, (iii) a wheel, (iv) a widget and a car, (v) a widget and a wheel, (vi) a car and a wheel, or (vii) a widget, a car and a wheel.

The phrase “based on” does not mean “based only on”, unless expressly specified otherwise. In other words, the phrase “based on” describes both “based only on” and “based at least on”.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restrict the meaning or scope of the claim.

Where a limitation of a first claim would cover one of a feature as well as more than one of a feature (e.g., a limitation such as “at least one widget” covers one widget as well as more than one widget), and where in a second claim that depends on the first claim, the second claim uses a definite article “the” to refer to the limitation (e.g., “the widget”), this does not imply that the first claim covers only one of the feature, and this does not imply that the second claim covers only one of the feature (e.g., “the widget” can cover both one widget and more than one widget).

When an ordinal number (such as “first”, “second”, “third” and so on) is used as an adjective before a term, that ordinal number is used (unless expressly specified otherwise) merely to indicate a particular feature, such as to allow for distinguishing that particular referenced feature from another feature that is described by the same term or by a similar term. For example, a “first widget” may be so named merely to allow for distinguishing it in one or more claims from a “second widget”, so as to encompass embodiments in which (1) the “first widget” is or is the same as the “second widget” and (2) the “first widget” is different than or is not identical to the “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; (3) does not indicate that either widget ranks above or below any other, as in importance or quality; and (4) does not indicate that the two referenced widgets are not identical or the same widget. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

When a single device or article is described herein, more than one device or article (whether or not they cooperate) may alternatively be used in place of the single device or article that is described. Accordingly, the functionality that is described as being possessed by a device may alternatively be possessed by more than one device or article (whether or not they cooperate).

Similarly, where more than one device or article is described herein (whether or not they cooperate), a single device or article may alternatively be used in place of the more than one device or article that is described. For example, a plurality of computer-based devices may be substituted with a single computer-based device. Accordingly, the various functionality that is described as being possessed by more than one device or article may alternatively be possessed by a single device or article.

The functionality and/or the features of a single device that is described may be alternatively embodied by one or more other devices which are described but are not explicitly described as having such functionality and/or features. Thus, other embodiments need not include the described device itself, but rather can include the one or more other devices which would, in those other embodiments, have such functionality/features.

Devices that are in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for weeks at a time. In addition, devices that are in communication with each other may communicate directly or indirectly through one or more intermediaries.

A description of an embodiment with several components or features does not imply that all or even any of such components and/or features are required. On the contrary, a variety of optional components are described to illustrate the wide variety of possible embodiments of the present invention(s). Unless otherwise specified explicitly, no component and/or feature is essential or required.

Further, although process steps, algorithms or the like may be described in a sequential order, such processes may be configured to work in different orders. In other words, any sequence or order of steps that may be explicitly described does not necessarily indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

Although a process may be described as including a plurality of steps, that does not indicate that all or even any of the steps are essential or required. Various other embodiments within the scope of the described invention(s) include other processes that omit some or all of the described steps. Unless otherwise specified explicitly, no step is essential or required.

Although a product may be described as including a plurality of components, aspects, qualities, characteristics and/or features, that does not indicate that all of the plurality are essential or required. Various other embodiments within the scope of the described invention(s) include other products that omit some or all of the described plurality.

An enumerated list of items (which may or may not be numbered) does not imply that any or all of the items are mutually exclusive, unless expressly specified otherwise. Likewise, an enumerated list of items (which may or may not be numbered) does not imply that any or all of the items are comprehensive of any category, unless expressly specified otherwise. For example, the enumerated list “a computer, a laptop, a PDA” does not imply that any or all of the three items of that list are mutually exclusive and does not imply that any or all of the three items of that list are comprehensive of any category.

Headings of sections provided in this patent application and the title of this patent application are for convenience only, and are not to be taken as limiting the disclosure in any way.

“Determining” something can be performed in a variety of manners and therefore the term “determining” (and like terms) includes calculating, computing, deriving, looking up (e.g., in a table, database or data structure), ascertaining and the like.

It will be readily apparent that the various methods and algorithms described herein may be implemented by, e.g., appropriately and/or specially-programmed general purpose computers and/or computing devices. Typically a processor (e.g., one or more microprocessors) will receive instructions from a memory or like device, and execute those instructions, thereby performing one or more processes defined by those instructions. Further, programs that implement such methods and algorithms may be stored and transmitted using a variety of media (e.g., computer readable media) in a number of manners. In some embodiments, hard-wired circuitry or custom hardware may be used in place of, or in combination with, software instructions for implementation of the processes of various embodiments. Thus, embodiments are not limited to any specific combination of hardware and software

A “processor” generally means any one or more microprocessors, CPU devices, computing devices, microcontrollers, digital signal processors, or like devices, as further described herein.

The term “computer-readable medium” refers to any medium that participates in providing data (e.g., instructions or other information) that may be read by a computer, a processor or a like device. Such a medium may take many forms, including but not limited to, non-volatile media, volatile media, and transmission media. Non-volatile media include, for example, optical or magnetic disks and other persistent memory. Volatile media include DRAM, which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during RF and IR data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave, or any other medium from which a computer can read.

The term “computer-readable memory” may generally refer to a subset and/or class of computer-readable medium that does not include transmission media such as waveforms, carrier waves, electromagnetic emissions, etc. Computer-readable memory may typically include physical media upon which data (e.g., instructions or other information) are stored, such as optical or magnetic disks and other persistent memory, DRAM, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, computer hard drives, backup tapes, Universal Serial Bus (USB) memory devices, and the like.

Various forms of computer readable media may be involved in carrying data, including sequences of instructions, to a processor. For example, sequences of instruction (i) may be delivered from RAM to a processor, (ii) may be carried over a wireless transmission medium, and/or (iii) may be formatted according to numerous formats, standards or protocols, such as Bluetooth™, TDMA, CDMA, 3G.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) could be used to store and manipulate the data types described herein. Likewise, object methods or behaviors of a database can be used to implement various processes, such as the described herein. In addition, the databases may, in a known manner, be stored locally or remotely from a device that accesses data in such a database.

The present invention can be configured to work in a network environment including a computer that is in communication, via a communications network, with one or more devices. The computer may communicate with the devices directly or indirectly, via a wired or wireless medium such as the Internet, LAN, WAN or Ethernet, Token Ring, or via any appropriate communications means or combination of communications means. Each of the devices may comprise computers, such as those based on the Intel® Pentium® or Centrino™ processor, that are adapted to communicate with the computer. Any number and type of machines may be in communication with the computer.

The present disclosure provides, to one of ordinary skill in the art, an enabling description of several embodiments and/or inventions. Some of these embodiments and/or inventions may not be claimed in the present application, but may nevertheless be claimed in one or more continuing applications that claim the benefit of priority of the present application. Applicants intend to file additional applications to pursue patents for subject matter that has been disclosed and enabled but not claimed in the present application.

What is claimed is:

1. A method, comprising:
causing, by a specially-programmed computerized processing device, a first portion of a haptic interface to be set to a first height different than a default interface height of the haptic interface; and
causing, by the specially-programmed computerized processing device and while the first portion of the haptic interface is set to the first height, a first Braille character to be output by the first portion of the haptic interface.

2. The method of claim 1, further comprising:
causing, by the specially-programmed computerized processing device, a second portion of the haptic interface to be set to a second height different than both the default interface height of the haptic interface and the first height.

3. The method of claim 2, further comprising:
causing, by the specially-programmed computerized processing device and while the second portion of the haptic interface is set to the second height, a second Braille character to be output by the second portion of the haptic interface.

4. The method of claim 1, further comprising:
receiving input by the first portion of the haptic interface.

5. The method of claim 4, wherein the input comprises touch input from a user of the haptic interface.

6. The method of claim 4, further comprising:
causing, by the specially-programmed computerized processing device and based on the received input, the first portion of the haptic interface to change height.

7. The method of claim 4, further comprising:
causing, by the specially-programmed computerized processing device and based on the received input, a second portion of the haptic interface to be set to a second height.

8. The method of claim 7, wherein the second height is different than both the default interface height of the haptic interface and the first height.

9. The method of claim 1, wherein the first portion comprises less than the whole haptic interface and wherein the remainder portion of the haptic interface is set to the default interface height of the haptic interface.

10. The method of claim 1, wherein the first height comprises a height lower than the default interface height of the haptic interface.

11. The method of claim 1, wherein the first height comprises a height higher than the default interface height of the haptic interface.

12. The method of claim 1, wherein the specially-programmed computerized processing device comprises a cellular telephone.

13. A specially-programmed computerized processing device, comprising:
a computerized processor;
a matrix of actuators in communication with the computerized processor;
a deformable surface coupled to the matrix of actuators; and
a memory in communication with the processor, the memory storing specially-programmed instructions that when executed by the computerized processor result in:
causing a first plurality of the actuators of the matrix of actuators to set a first portion of the deformable surface to a first height different than a default height of the deformable surface; and
causing, by at least one actuator of the plurality of actuators and while the first portion of the deformable surface is set to the first height, a first Braille character to be output by the first portion of the deformable surface.

14. The specially-programmed computerized processing device of claim 13, wherein the memory stores specially-programmed instructions that when executed by the computerized processor further result in:
causing a second plurality of the actuators of the matrix of actuators to set a second portion of the deformable surface to a second height different than both the default height of the deformable surface and the first height.

15. The specially-programmed computerized processing device of claim 14, wherein the memory stores specially-programmed instructions that when executed by the computerized processor further result in:
causing, by at least one actuator of the plurality of actuators and while the second portion of the deformable surface is set to the second height, a second Braille character to be output by the second portion of the deformable surface.

16. The specially-programmed computerized processing device of claim 13, further comprising:
a touch-sensitive input device coupled to at least one of the matrix of actuators and the deformable surface.

17. The specially-programmed computerized processing device of claim 16, wherein the memory stores specially-programmed instructions that when executed by the computerized processor further result in:
receiving, by the computerized processor, an indication of touch input received by the touch-sensitive input device; and
causing, in response to the indication of the received input, the matrix of actuators to alter the height of at least one portion of the deformable surface.

18. A non-transitory computer-readable storage medium storing specially-programmed instructions that when executed by a computerized processing device result in:
Causing a first portion of a haptic interface to be set to a first height different than a default interface height of the haptic interface; and
causing, while the first portion of the haptic interface is set to the first height, a first Braille character to be output by the first portion of the haptic interface.
